(19) United States
(12) Patent Application Publication
(10) Pub. No.: US 2026/0214176 A1
(43) Pub. Date: Jul. 23, 2026

(54) MEDIUM DISCHARGE DEVICE AND IMAGE READING APPARATUS

(71) Applicant: SEIKO EPSON CORPORATION, TOKYO (JP)

(72) Inventor: Kazuhiko ARIMORI, KITAKYUSHU-SHI (JP)

(21) Appl. No.: 19/457,306

(22) Filed: Jan. 23, 2026

(30) Foreign Application Priority Data
Jan. 23, 2025 (JP) 2025-009952

(51) Int. Cl. H04N 1/12; H04N 1/00

(52) U.S. Cl. CPC H04N 1/1215; H04N 1/00631; H04N 1/00649; H04N 2201/0081

(57) ABSTRACT

According to an aspect of the present disclosure, there is provided a medium discharge device including a discharge roller pair, a roller drive section configured to drive the discharge roller pair, a discharge tray including a placement surface on which a medium discharged from the discharge roller pair is placed, the discharge tray being capable of changing a placement angle in a discharge direction of the placement surface, and a control section configured to control operations of the roller drive section and a placement angle changing section. The discharge tray is capable of changing the placement angle to a first placement angle and a second placement angle, the discharge roller pair is capable of changing discharge speed to first discharge speed, second discharge speed lower than the first discharge speed, and third discharge speed lower than the second discharge speed, and the control section changes the discharge speed from the first discharge speed to the second discharge speed while the medium is discharged at the second placement angle, changes the discharge speed from the first discharge speed to the third discharge speed while the medium is discharged at the first placement angle, and discharges the medium.

The present application is based on, and claims priority from JP Application Serial Number 2025-009952, filed Jan. 23, 2025, the disclosure of which is hereby incorporated by reference herein in its entirety.

### BACKGROUND

### 1. Technical Field

The present disclosure relates to a medium discharge device and an image reading apparatus.

### 2. Related Art

Examples of the related art of the device of this type include a device disclosed in JP-A-2023-137046.

JP-A-2023-137046 discloses first conveyance speed can be changed to second conveyance speed lower than the first conveyance speed according to a size of a medium and the second conveyance speed can be changed according to the size of the medium.

JP-A-2023-137046 is an example of the related art.

However, when the first conveyance speed is reduced to the second conveyance speed and when the second conveyance speed increased to the first conveyance speed, there is a problem in that a load of a drive motor increases and power consumption increases.

### SUMMARY

According to an aspect of the present disclosure, there is provided a medium discharge device including: a discharge roller pair configured to discharge a medium in a discharge direction; a roller drive section configured to drive rollers configuring the discharge roller pair; a discharge tray including a placement surface on which the medium discharged from the discharge roller pair is placed, the discharge tray changing a placement angle in the discharge direction of the placement surface; a placement angle changing section configured to change the placement angle of the discharge tray; and a control section configured to control operations of the roller drive section and the placement angle changing section, wherein the discharge tray changes, with the placement angle changing section, the placement angle to a first placement angle and a second placement angle larger than the first placement angle, the discharge roller pair changes, with the roller drive section, discharge speed to first discharge speed, second discharge speed lower than the first discharge speed, and third discharge speed lower than the second discharge speed, and the control section changes the discharge speed from the first discharge speed to the second discharge speed while the medium is discharged at the second placement angle, changes the discharge speed from the first discharge speed to the third discharge speed while the medium is discharged at the first placement angle, and discharges the medium.

According to another aspect of the present disclosure, there is provided an image reading apparatus including: the medium discharge device described in any one of first to seventh aspects explained below; and a reading section located further upstream than the medium discharge device in a conveyance direction of the medium and configured to read an image of the conveyed medium.

### BRIEF DESCRIPTION OF THE DRAWINGS

FIG. 1 is a schematic side configuration diagram of an image reading apparatus in a first embodiment.

FIG. 2 is a main part enlarged diagram of FIG. 1.

FIG. 3 is a schematic diagram of a main part configuration of a discharge angle changing section in the first embodiment.

FIG. 4 is a diagram illustrating a relationship between discharge speed and alignment.

FIG. 5 is a diagram illustrating a relationship among discharge speed, a placement angle, and alignment.

FIG. 6 is a diagram illustrating a relationship between a discharge angle and alignment.

FIG. 7 is a control table in the first embodiment.

FIG. 8 is a control table in a second embodiment.

FIG. 9 is a control table in a third embodiment.

### DESCRIPTION OF EMBODIMENTS

First, the present disclosure is schematically explained.

According to a first aspect of the present disclosure, there is provided a medium discharge device including: a discharge roller pair configured to discharge a medium in a discharge direction; a roller drive section configured to drive rollers configuring the discharge roller pair; a discharge tray including a placement surface on which the medium discharged from the discharge roller pair is placed, the discharge tray changing a placement angle in the discharge direction of the placement surface; a placement angle changing section configured to change the placement angle of the discharge tray; and a control section configured to control operations of the roller drive section and the placement angle changing section, wherein the discharge tray changes, with the placement angle changing section, the placement angle to a first placement angle and a second placement angle larger than the first placement angle, the discharge roller pair changes, with the roller drive section, discharge speed to first discharge speed, second discharge speed lower than the first discharge speed, and third discharge speed lower than the second discharge speed, and the control section changes the discharge speed from the first discharge speed to the second discharge speed while the medium is discharged at the second placement angle, changes the discharge speed from the first discharge speed to the third discharge speed while the medium is discharged at the first placement angle, and discharges the medium.

According to this aspect, the discharge tray is capable of changing, with the placement angle changing section, the placement angle to a first placement angle and the second placement angle larger than the first placement angle. Accordingly, it is easy to ensure alignment of the medium discharged onto the placement surface of the discharge tray.

Further, the discharge roller pair is capable of changing, with the roller drive section, the discharge speed to the first discharge speed, the second discharge speed lower than the first discharge speed, and the third discharge speed lower than the second discharge speed. The control section is configured to change the discharge speed from the first discharge speed to the second discharge speed while the medium is discharged at the second placement angle, change the discharge speed from the first discharge speed to the third discharge speed while the medium is discharged at the first placement angle, and discharge the medium.

Accordingly, the discharge speed of the discharge roller pair at the second placement angle is reduced from the first discharge speed to the second discharge speed. Since a degree of this deceleration is smaller than a degree of deceleration from the first discharge speed to the third discharge speed, a load of the roller drive section decreases by the smallness of the degree. Therefore, it is possible to suppress power consumption involved in the deceleration while securing alignment of the medium. When the discharge speed is increased from the second discharge speed to the first discharge speed, since a degree of this acceleration is smaller than a degree of acceleration from the third discharge speed to the first discharge speed, the load of the roller drive section decreases by the smallness of the degree. Therefore, it is possible to suppress power consumption.

A medium discharge device according to a second aspect of the present disclosure is an aspect dependent from the first aspect, wherein the control section changes the discharge speed from the first discharge speed to the second discharge speed when the discharge tray discharges a trailing end portion of the medium at the second placement angle, changes the discharge speed from the first discharge speed to the third discharge speed when the discharge tray discharges the trailing end portion of the medium at the first placement angle, and discharges the medium.

According to this aspect, while the discharge roller pair is discharging the medium, timing when the discharge speed is reduced from the first discharge speed to the second discharge speed is when the trailing end portion of the medium is discharged. Timing when the discharge speed is reduced from the first discharge speed to the third discharge speed is also when the trailing end portion of the medium is discharged. Accordingly, since a time in which the discharge speed is reduced decreases, it is possible to suppress power consumption involved in the deceleration. Since the time in which the discharge speed is reduced decreases, it is possible to smoothly discharge a medium to be discharged next without reducing discharge speed of the medium.

A medium discharge device according to a third aspect of the present disclosure is an aspect dependent from the first aspect wherein a deceleration degree between the first discharge speed and the second discharge speed at the second placement angle is smaller than a deceleration degree between the first discharge speed and the third discharge speed at the first placement angle.

Note that this aspect can also be dependent from the second aspect.

According to this aspect, the deceleration degree between the first discharge speed and the second discharge speed at the second placement angle is smaller than the deceleration degree between the first discharge speed and the third discharge speed at the first placement angle. Accordingly, it is possible to further suppress power consumption involved in the deceleration.

A medium discharge device according to a fourth aspect of the present disclosure is an aspect dependent from the first aspect, wherein the control section sets the placement angle to the first placement angle or the second placement angle based on information concerning a size and a placement direction of the medium.

Note that this aspect can also be dependent from the second aspect or the third aspect.

According to this aspect, the control section sets the placement angle to the first placement angle or the second placement angle based on information concerning the size and the placement direction of the medium. That is, the control section is configured to set the placement angle to the first placement angle, the second placement angle, or the like based on the information such as the size of the medium. Accordingly, it is possible to suppress the power consumption involved in the deceleration while securing the alignment of the medium.

A medium discharge device according to a fifth aspect of the present disclosure is an aspect dependent from the fourth aspect, wherein the control section sets the placement angle to the first placement angle or the second placement angle based on a basis weight of the medium.

According to this aspect, the control section is configured to set the placement angle to the first placement angle or the second placement angle based on the basis weight of the medium. Accordingly, it is possible to further suppress the power consumption involved in the deceleration while securing the alignment of the medium.

A medium discharge device according to a sixth aspect of the present disclosure is an aspect dependent from the fourth aspect, wherein the placement surface of the discharge tray extends and contracts in the discharge direction, the medium discharge device includes a placement surface length changing section configured to change length of the placement surface of the discharge tray, and the control section sets the length of the placement surface based on the information concerning the size and the placement direction of the medium.

According to this aspect, the control section sets the length of the placement surface based on the information concerning the size and the placement direction of the medium. Accordingly, it is possible to place the entire medium on the placement surface of the discharge tray and it is possible to suppress the power consumption involved in the deceleration while securing the alignment of the medium.

A medium discharge device according to a seventh aspect of the present disclosure is an aspect dependent from the fourth aspect, wherein the discharge roller pair changes a discharge angle at which the medium is discharged in the discharge direction, the medium discharge device includes a discharge angle changing section configured to change the discharge angle, and the control section sets the discharge angle according to a basis weight of the medium.

According to this aspect, the control section is configured to set the discharge angle according to the basis weight of the medium. Accordingly, it is possible to further suppress the power consumption involved in the deceleration while securing the alignment of the medium.

According to an eighth aspect of the present disclosure, there is provided an image reading apparatus including: the medium discharge device according to any one of the first to seventh aspects; and a reading section located further upstream than the medium discharge device in a conveyance direction of the medium and configured to read an image of the conveyed medium.

According to this aspect, the image reading apparatus can obtain the effects based on the medium discharge device according to any one of the first to seventh aspects.

### EMBODIMENTS

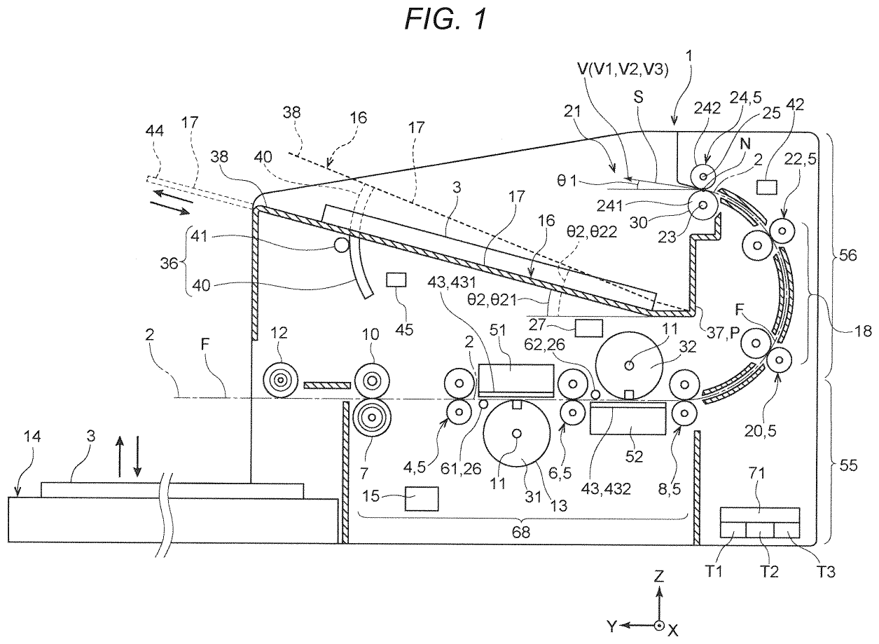

A medium discharge device according to an embodiment of the present disclosure and an image reading apparatus including the medium discharge device are specifically explained below with reference to FIGS. 1 to 9.

In the following explanation, three axes orthogonal to one another are respectively represented as an X axis, a Y axis, and a Z axis as illustrated in the figures. Directions indicated by arrows of the three axes (X, Y, and Z) are + directions of the directions and directions opposite to the directions are − directions. A Z-axis direction is equivalent to the vertical direction, that is, the direction in which the gravity acts, a +Z direction indicates the vertically upward direction, and a −Z direction indicates the vertically downward direction. An X-axis direction and a Y-axis direction are equivalent to the horizontal direction. A +Y direction indicates the front direction of the image reading apparatus and a −Y direction indicates the rear direction of the apparatus. A +X direction indicates the rightward direction of the apparatus, and a −X direction indicates the leftward direction of the apparatus.

### Overall Structure of the Image Reading Apparatus

An image reading apparatus 1 in the present embodiment is a scanner capable of reading an image of a medium serving as a document. Here, the image means an image visually recorded on the medium and is, for example, a character, a figure, a table, a picture, or a photograph. The medium is not limited to a sheet and includes a card, a booklet, and the like. The image reading apparatus 1 is not limited to a scanner and may be a copying machine, a facsimile machine, or the like.

As illustrated in FIG. 1, the image reading apparatus 1 includes two reading sections, that is, a first reading section 51 and a second reading section 52 as reading sections that read an image of a medium 3. Further, the image reading apparatus 1 includes a first conveyance roller 4 that conveys the medium 3 in a conveyance direction F along a conveyance path 2 and is provided upstream of the first reading section 51 in the conveyance direction F, a second conveyance roller 6 provided upstream of the second reading section 52 located further downstream than the first reading section 51, and a third conveyance roller 8 provided downstream of the second reading section 52.

A roller pair of a feeding roller 10 and a separation roller 7 is disposed upstream of the first conveyance roller 4 in the conveyance direction F. The feeding roller 10 is a driving roller that rotates with power of a first driving section 15 and conveys the medium 3 in the conveyance direction F. The separation roller 7 is a driving roller that rotates with power of a not-illustrated driving source and is a roller that separates one medium from a plurality of media 3.

Here, the separation roller 7 rotates, with the power of the driving source, in a direction in which the medium 3 is fed to the upstream side (the +Y direction) in the conveyance direction F. The separation roller 7 includes a not-illustrated torque limiter and, when torque exceeding a set value is applied to the torque limiter, is driven to rotate in a direction of feeding the medium 3 to the downstream side (the −Y direction) in the conveyance direction F.

A pick roller 12 is disposed upstream of the separation roller 7. The pick roller 12 is a driving roller that rotates with the power of the first driving section 15 like the feeding roller 10 and delivers the medium 3 in the conveyance direction F. The first conveyance roller 4, the second conveyance roller 6, and the third conveyance roller 8, which form a conveyance section 5 that conveys the medium 3 in the conveyance direction F, also include driving rollers that rotate with the power of the first driving section 15.

As illustrated in FIG. 1, in the present embodiment, a curved reversal path 18 is provided downstream of a straight path 68 from the feeding roller 10 to the third conveyance roller 8, that is, downstream of the third conveyance roller 8. In the curved reversal path 18, a fourth conveyance roller 20, a fifth conveyance roller 22, and a discharge roller pair 24 are disposed in this order in the conveyance direction F.

A discharge tray 16 that receives the medium 3 discharged from the curved reversal path 18 is disposed above the straight path 68 to achieve compactness.

In FIG. 1, reference numeral 71 denotes a control section. The control section 71 controls driving of the first driving section 15 and driving of a second driving section 27 explained below according to the conveyance of the medium 3. The first driving section 15 and the second driving section 27 include motors.

The control section 71 includes a CPU, a flash ROM, and a RAM. The CPU performs various kinds of arithmetic processing according to programs stored in the flash ROM and controls an operation of the entire image reading apparatus 1. The flash ROM, which is an example of storage means, is a readable and writable nonvolatile memory. The RAM, which is an example of storage means, temporarily stores various information.

In FIG. 1, reference numeral 14 denotes a medium setting section in which the medium 3 to be read is set. The medium 3 on the medium setting section 14 is conveyed on the conveyance path 2 and finally discharged to the discharge tray 16.

The medium setting section 14 is configured to move up and down. When media 3 set in the medium setting section 14 is fed in the conveyance direction F, first, the medium setting section 14 is moved upward (in the +Z direction) by power transmitted from a not-illustrated driving source and the medium 3 located at the top of the set media 3 stops in a state of being in contact with the pick roller 12. When the pick roller 12 rotates in that state, the medium 3 is fed in the conveyance direction F and the leading end of the medium 3 reaches a nip position of the roller pair of the feeding roller 10 and the separation roller 7.

In the case of a multi-feed state in which a plurality of media 3 are fed, the media 3 are separated into one medium 3 by the separation roller 7, the one medium 3 is conveyed in the conveyance direction F by the first conveyance roller 4, and reading of an image on a first surface of the medium 3 is executed by the first reading section 51. Further, the medium 3 for which the reading has been executed by the first reading section 51 is conveyed by the second conveyance roller 6 and reading of an image on a second surface on the opposite side of the first surface of the medium 3 is executed by the second reading section 52.

The medium 3 for which the reading has been executed by the second reading section 52 is sent to the curved reversal path 18 by the third conveyance roller 8, conveyed by the fourth conveyance roller 20 and the fifth conveyance roller 22, and discharged to the discharge tray 16 by the discharge roller pair 24.

As illustrated in FIG. 1, in the present embodiment, the first reading section 51 and the second reading section 52 that read an image of the medium 3 conveyed in the conveyance direction F include a first light-transmitting member 431 and a second light-transmitting member 432, which are light-transmitting members 43 disposed between the first reading section 51 and the second reading section 52 and the conveyance path 2.

As illustrated in FIG. 1, a first rotating member 31 and a second rotating member 32 serving as rotating members are disposed on the opposite side of the first reading section 51 and the second reading section 52 of the first light-transmitting member 431 and the second light-transmitting member 432. The first rotating member 31 and the second rotating member 32 are rotating members disposed to face the first reading section 51 and the second reading section 52 and capable of rotating around a shaft 11. The first rotating member 31 and the second rotating member 32 have a substantially cylindrical shape and are formed with length enough for covering reading ranges (in the X-axis direction) of the first reading section 51 and the second reading section 52.

As illustrated in FIG. 1, the first rotating member 31 and the second rotating member 32 rotate around the shaft 11 with power of the second driving section 27, which is a common driving source. Rotational motions of the first rotating member 31 and the second rotating member 32 are controlled by the control section 71.

The first rotating member 31 and the second rotating member 32 may be configured to rotate with power of not the common second driving section 27 but individual motors.

The first reading section 51, the first light-transmitting member 431, and the second rotating member 32 are disposed above the conveyance path 2. The second reading section 52, the second light-transmitting member 432, and the first rotating member 31 are disposed below the conveyance path 2.

As illustrated in FIG. 1, in the present embodiment, the image reading apparatus 1 includes a lower unit 55 and an upper unit 56. The upper unit 56 is configured to be openable and closable with respect to the lower unit 55 by turning in the up-down direction with a not-illustrated opening and closing mechanism.

The lower unit 55 includes the second reading section 52, the second light-transmitting member 432, and the first rotating member 31. The upper unit 56 includes the first reading section 51, the first light-transmitting member 431, and the second rotating member 32. In a state in which the upper unit 56 is closed with respect to the lower unit 55, as illustrated in FIG. 1, the second light-transmitting member 432 and the second rotating member 32 are disposed to face each other and the first light-transmitting member 431 and the first rotating member 31 are disposed to face each other.

In a state in which the upper unit 56 is opened with respect to the lower unit 55, although not illustrated, the second light-transmitting member 432 and the second rotating member 32 are configured not to face each other and the first light-transmitting member 431 and the first rotating member 31 are configured not to face each other. That is, facing surfaces of the lower unit 55 and the upper unit 56 are exposed and a user can access the facing surfaces.

As illustrated in FIG. 1, in the present embodiment, the image reading apparatus 1 includes a first conveyance assistance section 61 and a second conveyance assistance section 62 as conveyance assistance sections that face the first light-transmitting member 431 and the second light-transmitting member 432, are disposed upstream of the first rotating member 31 and the second rotating member 32, and assist conveyance of the medium 3. Here, the first conveyance assistance section 61 and the second conveyance assistance section 62 include driving rollers 26 called platen rollers 26 that rotate with power of the first driving section 15 transmitted thereto.

The image reading apparatus 1 includes a medium discharge device 21.

As illustrated in FIGS. 1 to 3, the medium discharge device 21 includes the discharge roller pair 24 that discharges the medium 3, a roller drive section 42 that drives a discharge driving roller 241 explained below, which is a roller configuring the discharge roller pair 24, and the discharge tray 16 including a placement surface 17 on which the discharged medium 3 is placed. The discharge roller pair 24 is configured to be capable of changing a discharge angle θ1 in a discharge direction S of the medium 3 discharged from the discharge roller pair 24. The discharge tray 16 is configured to be capable of changing a placement angle θ2 in the discharge direction S of the placement surface 17. The discharge angle θ1 means an angle formed by a horizontal line and a line orthogonal to a line connecting a first shaft 23 of the first roller 241, which is one of the discharge roller pair 24, and a second shaft 25 of a second roller 242, which is the other of the discharge roller pair 24. The placement angle θ2 means an angle formed by the placement surface 17 and the horizontal plane.

At least one of the discharge angle θ1 and the placement angle θ2 can be changed according to, for example, discharge speed of the medium 3 discharged from the discharge roller pair 24.

In the present embodiment, discharge speed V of the medium 3 discharged from the discharge roller pair 24 driven by the roller drive section 42 is set such that the medium 3 can be discharged at high discharge speed of 150 ppm or more, the medium 3 can be discharged at low discharge speed of approximately 40 ppm, and the medium 3 can be discharged at discharge speed between the high discharge speed and the low discharge speed. Here, ppm is a unit of the discharge speed V and is the number of media discharged in one minute, and 150 ppm means that 150 media are discharged in one minute.

In the medium discharge device 21 in the present embodiment, the discharge speed V can be set by the user. It goes without saying that a range of the discharge speed V is not limited to the range described above.

### Discharge Angle Changing Section

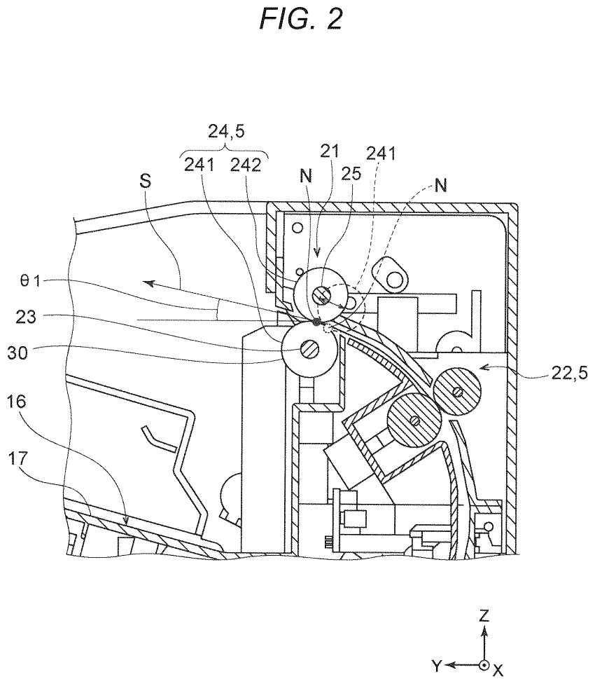

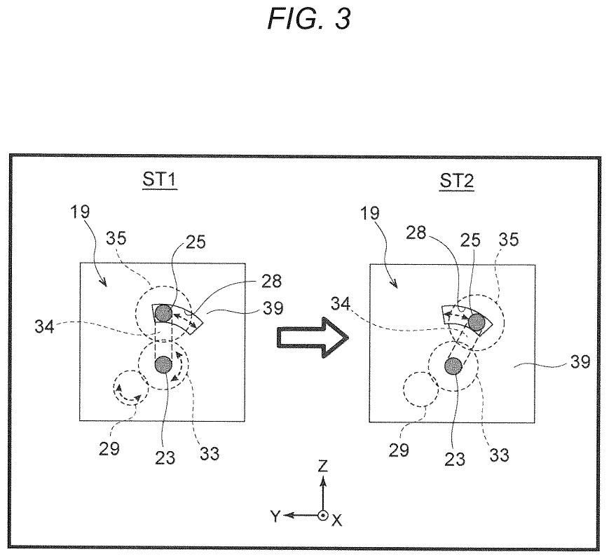

As illustrated in FIGS. 2 and 3, the medium discharge device 21 includes a discharge angle changing section 19 that enables the discharge angle θ1 to be changed. The discharge angle changing section 19 in the present embodiment is configured as explained below as an example.

The discharge angle changing section 19 is configured to move the second roller 242, which is one of the discharge roller air 24, along a circumferential surface 30 of the first roller 241 with respect to the first roller 241, which is one of the discharge roller pair 24, to change a nip position N between the first roller 241 and the second roller 242. Here, the first roller 241 is the discharge driving roller 241 (denoted by the same reference numeral) and the second roller 242 is a discharge driven roller 242 (denoted by the same reference numeral). Reference numeral 23 denotes a first shaft, which is a shaft of the discharge driving roller 241, and reference numeral 25 denotes a second shaft, which is a shaft of the discharge driven roller 242.

An example of a specific structure that enables the nip position N to be changed is explained with reference to FIG. 3. A first gear 33 for moving the discharge driven roller 242 as explained below is attached to the first shaft 23. The first gear 33 is attached to be capable of rotating with the first shaft 23 as a rotation center. That is, the first gear 33 is capable of rotating with respect to the first shaft 23 in a state in which the discharge driving roller 241 is stopped.

The first gear 33 meshes with a transmission gear 29. The transmission gear 29 rotates with power transmitted from a motor, which is a not-illustrated driving source, and rotates the first gear 33 with respect to the first shaft 23 according to the rotation. A rotational motion of the transmission gear 29 is controlled by the control section 71.

Both end portions of the second shaft 25 are slidably attached to sliding slits 28 provided in a frame 39, which is a structural member of the medium discharge device 21. Further, a planetary gear 35 is attached to the second shaft 25 in a state of meshing with the first gear 33. The planetary gear 35 is attached to be capable of rotating with the second shaft 25 as a rotation center. Further, the planetary gear 35 is configured to be capable of performing planetary movement along the circumferential surface of the first gear 33 via a planetary gear arm 34. That is, when the first gear 33 rotates, the planetary gear 35 also rotates following the rotation of the first gear 33 but performs the planetary movement along the circumferential surface of the first gear 33 because the planetary gear arm 34 is present. When the planetary gear 35 performs the planetary movement, the second shaft 25 integrated with the planetary gear 35 also moves. Thus, the sliding slits 28 are formed in a slit shape that enables the planetary movement.

Accordingly, when the planetary gear 35 performs the planetary movement, the second shaft 25 also slides in the sliding slits 28, the discharge driven roller 242 moves along the circumferential surface 30 of the discharge driving roller 241, and the nip position N changes. That is, a state ST1 illustrated on the left of FIG. 3 changes to a state ST2 illustrated on the right. When the nip position N changes, the discharge angle θ1 changes.

### Placement Angle Changing Section

As illustrated in FIG. 1, the medium discharge device 21 in the present embodiment includes a placement angle changing section 36 that enables the placement angle θ2 to be changed. The placement angle changing section 36 in the present embodiment is configured as explained below as an example.

The placement angle changing section 36 is configured to be capable of moving up and down on a downstream end portion 38 side in the discharge direction S of the placement surface 17 with an upstream end portion 37 in the discharge direction S of the placement surface 17 as a starting point P.

Here, the upstream end portion 37 of the placement surface 17 serves as a turning fulcrum and a rack 40 is attached to the downstream end portion 38. A pinion 41 that meshes with the rack 40 is fixed to a not-illustrated frame of the medium discharge device 21. When the pinion 41 rotates with power transmitted from a motor serving as a not-illustrated driving source, the rack 40 moves, whereby the placement surface 17 moves in the up-down direction, and the placement angle θ2 changes. In FIG. 1, the placement angle θ2 of a position indicated by a broken line is larger than the placement angle θ2 of a position indicated by a solid line on the placement surface 17. A rotational motion of the pinion 41 is controlled by the control section 71.

### Placement Surface Length Changing Section

As illustrated in FIG. 1, in the medium discharge device 21 in the present embodiment, the placement surface 17 of the discharge tray 16 is configured to be extendable in the discharge direction S. That is, the discharge tray 16 includes an extension tray 44. The medium discharge device 21 further includes a placement surface length changing section 45 that changes the length of the placement surface 17 of the discharge tray 16. The extension tray 44 is capable of being displaced between a basic length (a state indicated by a solid line in FIG. 1) and a state in which the length of the placement surface 17 is increased (a state indicated by a broken line in FIG. 1) by being moved to extend and contract in the discharge direction S by the placement surface length changing section 45.

The placement surface length changing section 45 in the present embodiment is configured as explained below as an example. The placement surface length changing section 45 is configured to be moved to extend and contract by a not-illustrated rack and pinion mechanism to which power of a not-illustrated motor is transmitted.

### (1) Relationship Between Discharge Speed and Alignment

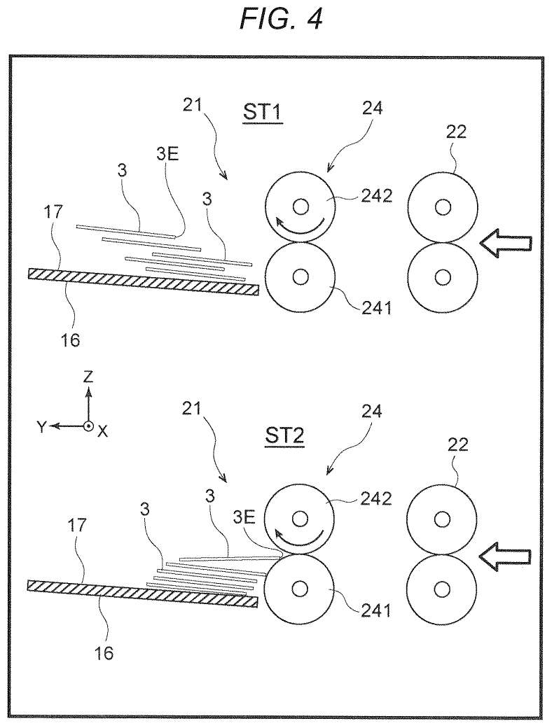

A relationship between the discharge speed V of the medium 3 discharged from the discharge roller pair 24 and alignment on the placement surface 17 is explained with reference to FIG. 4. A state of ST1 in FIG. 4 indicates that, when the discharge speed V is too high, the media 3 are scattered on the placement surface 17 and the alignment is deteriorated. A state of ST2 in FIG. 4 indicates that, when the discharge speed V is too low, the alignment is deteriorated because the trailing end portion of the medium 3 remains on the discharge driving roller 241. In FIG. 4, the placement angle θ2 is the same angle in the state of ST1 and the state of ST2.

### (2) Relationship Among Discharge Speed, a Placement Angle, and Alignment

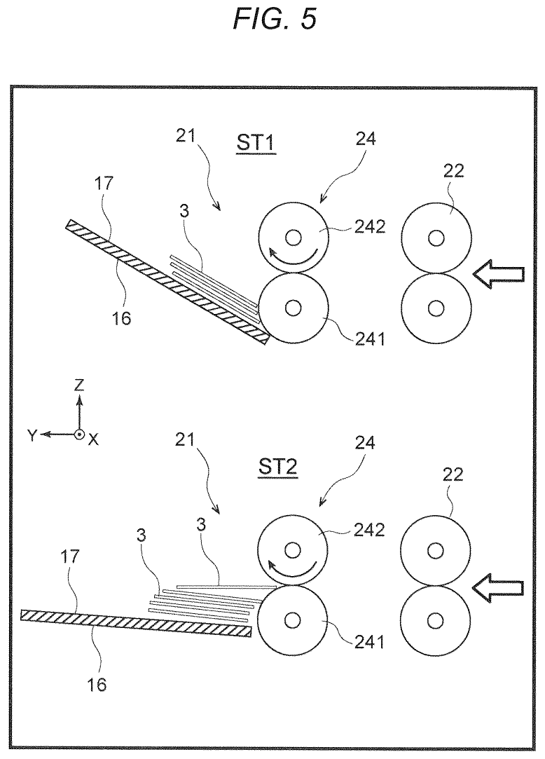

A relationship among the discharge speed V, the placement angle θ2, which is an angle of the placement surface 17 of the discharge tray 16, and alignment on the placement surface 17 of the medium 3 discharged from the discharge roller pair 24 is explained with reference to FIG. 5. A state of ST1 in FIG. 5 indicates that, when the placement angle θ2 is a steep angle, the alignment is not deteriorated because the medium 3 discharged onto the placement surface 17 moves downward with its own weight even when the discharge speed V is increased. A state of ST2 in FIG. 5 indicates that, when the placement angle θ2 is a gentle angle, since it is difficult to obtain the effect of the own weight, the alignment is deteriorated unless the discharge speed V is set lower than that in the case of ST1 but, when the discharge speed V is too low, the alignment is deteriorated because the trailing end portion of the medium 3 remains on the discharge driving roller 241.

### (3) Relationship Between a Discharge Angle and Alignment

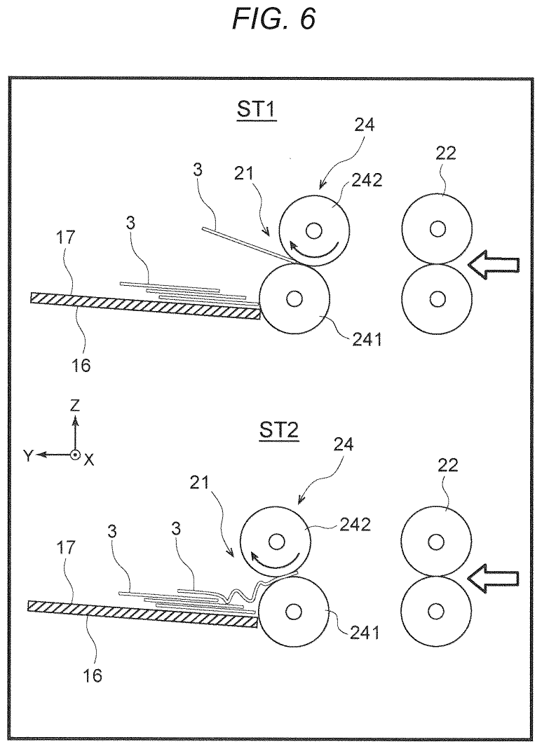

A relationship between the discharge speed V and the alignment on the placement surface 17 of the medium 3 discharged from the discharge roller pair 24 is explained with reference to FIG. 6. A state of ST1 in FIG. 6 indicates that, when the discharge angle θ1 faces excessively upward, since the discharged medium 3 easily flies, the alignment is deteriorated. A state of ST2 in FIG. 6 indicates that, when the discharge angle θ1 faces slightly further downward than the horizontal, the leading end portion of the discharged medium 3 comes into contact with the placement surface 17 and serves as a brake, a jam easily occurs, and the alignment is deteriorated.

### First Embodiment

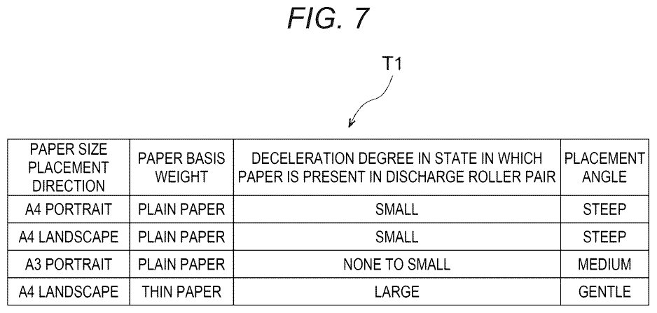

Subsequently to the explanation of the overall structure of the image reading apparatus 1 explained above, the medium discharge device 21 in a first embodiment is explained below with reference FIGS. 1 and 7, although the explanation is partially redundant.

The medium discharge device 21 in the first embodiment includes the discharge roller pair 24 that discharges the medium 3 in the discharge direction S, the roller drive section 42 that drives the discharge driving roller 241, which is the roller configuring the discharge roller pair 24, the discharge tray 16 including the placement surface 17, on which the medium 3 discharged from the discharge roller pair 24 is placed, and capable of changing the placement angle θ2 in the discharge direction S of the placement surface 17, the placement angle changing section 36 that changes the placement angle θ2 of the discharge tray 16, and the control section 71 that controls operations of the roller drive section 42 and the placement angle changing section 36.

The discharge tray 16 is configured to be capable of changing, with the placement angle changing section 36,. The placement angle θ2 to a first placement angle θ21 (the position indicated by the solid line in FIG. 1), a second placement angle θ22 (the position indicated by the broken line in FIG. 1) larger than the first placement angle θ21, and the like. The discharge roller pair 24 is configured to be capable of changing, with the roller drive section 42, the discharge speed V to first discharge speed V1, second discharge speed V2 lower than the first discharge speed V1, third discharge speed V3 lower than the second discharge speed V2, and the like.

The control section 71 is configured to change the discharge speed V from the first discharge speed V1 to the second discharge speed V2 while the discharge roller pair 24 is discharging the medium 3 at the second placement angle θ22, change the discharge speed V from the first discharge speed V1 to the third discharge speed V3 while the discharge roller pair 24 is discharging the medium 3 at the first placement angle θ21, and discharge the medium 3.

Here, “while the discharge roller pair 24 is discharging the medium 3” means a state in which the medium 3 is moved in the conveyance direction S only by the discharge roller pair 24. Note that, “while the discharge roller pair 24 is discharging the medium 3” may be from a state in which the medium 3 is moved in the discharge direction S by both of the discharge roller pair 24 and the fifth conveyance roller 22 to a state in which the medium 3 is moved only by the discharge roller pair 24. In this case, the discharge roller pair 24 and the fifth conveyance roller 22 are synchronized to have the same feeding speed.

In the present embodiment, the control section 71 is configured to change the discharge speed V from the first discharge speed V1 to the second discharge speed V2 when the discharge roller pair 24 discharges a trailing end portion 3E (FIG. 4) of the medium 3 at the second placement angle θ22, change discharge speed V from the first discharge speed V1 to the third discharge speed V3 when the discharge roller pair 24 discharges the trailing end portion 3E of the medium 3 at the first placement angle θ21, and discharge the medium 3.

Here, “when the discharge roller pair 24 discharges the trailing end portion 3E of the medium 3” means a state in which the trailing end portion 3E of the medium 3 passes through a nip position of the fifth conveyance roller 22 located adjacent to the upstream side in the conveyance path 2 and the medium 3 is discharged in the discharge direction S only by the discharge roller pair 24 and means timing when the trailing end portion 3E of the medium 3 deviates from the nip position of the discharge roller pair 24. That is, the control section 71 is configured to, when the trailing end portion 3E of the medium 3 deviates from the nip position of the discharge roller pair 24, change the discharge speed V from the first discharge speed V1 to the second discharge speed V2 or change the discharge speed V from the first discharge speed V1 to the third discharge speed V3.

In the present embodiment, a deceleration degree (V1−V2) between the first discharge speed V1 and the second discharge speed V2 at the second placement angle θ22 is set to be smaller than a deceleration degree (V1−V3) between the first discharge speed V1 and the third discharge speed V3 at the first placement angle θ21. That is, the discharge speeds are set to be (V1−V2)<(V1−V3).

In the present embodiment, the control section 71 is configured to set the placement angle θ2 to the first placement angle θ21, the second placement angle θ22, or the like based on information concerning a size and a placement direction of the medium 3.

Further, the control section 71 is configured to set the placement angle θ2 to the first placement angle θ21, the second placement angle θ22, or the like based on a basis weight of the medium 3, that is, a paper basis weight.

FIG. 7 is a control table T1 for sizes (A4, A3, and the like) and placement direction (portrait and landscape) of the medium 3 such as paper and the placement angle θ2 and the discharge speed V set based on the basis weight of the medium 3. As illustrated in FIG. 1, the control section 71 includes the control table T1 to executable.

The discharge speed V is indicated by the deceleration degrees (V1−V2) and (V1−V3) described above. The deceleration degree (V1−V2) is indicated by “small” and the deceleration degree (V1−V3) is indicated by “large”. The deceleration degree “from none to small” is between “small” and “large”. The deceleration degree being “small” is equivalent to power consumption involved in a reduction of the discharge speed V being able to be suppressed more than in the case of “large”.

A state in which the placement angle θ2 is the first placement angle θ21 is indicated by “gentle” and a state in which the placement angle θ2 is the second placement angle θ22 is indicated by “steep”. The placement angle θ being “medium” is between “gentle” and “steep”.

The basis weight of the medium 3 is indicated by “plain paper” and “thin paper” as examples of the paper basis weight. The plain paper has a larger basis weight than thin paper.

The control table T1 is created in advance from the viewpoint of making it possible to suppress the power consumption involved in the reduction of the discharge speed V while ensuring the alignment of the medium 3 discharged onto the placement surface 17 taking into account “(1) the relationship between the discharge speed and the alignment”, “(2) the relationship among the discharge speed, the placement angle, and the alignment”, and “(3) the relationship between the discharge angle and the alignment” explained above.

### Explanation of Decelerated Discharge in the First Embodiment

When receiving information concerning a paper size and a placement direction and information concerning paper basis weight, the control section 71 drives the placement angle changing section 36 to set the placement angle θ2 based on the control table T1. Further, the discharge speed V, that is, the deceleration degree is set.

Specifically, in the case of “plain paper” of “A4 portrait”, the placement angle θ2 is set to “steep” and the deceleration degree is set to “small”. Also in the case of “plain paper” of “A4 landscape”, the placement angle θ2 is set to “steep” and the deceleration degree is set to “small”. In the case of “thin paper” of “A4 landscape”, the placement angle θ2 is set to “gentle” and the deceleration degree is set to “large”. In the case of “plain paper” of “A3 portrait”, the placement angle θ2 is set to “medium” and the deceleration degree is set to “from none to small”, that is, between “small” and “large”.

Accordingly, the alignment of the medium 3 discharged onto the placement surface 17 is secured. Further, since “small” is present in the deceleration degree of the discharge speed V, the power consumption involved in the deceleration can be suppressed by the deceleration degree.

### Explanation of Effects of the First Embodiment

(1) In the present embodiment, the discharge tray 16 is capable of changing, with the placement angle changing section 36, the placement angle θ2 to the first placement angle θ21 and the second placement angle θ22 larger than the first placement angle θ21. Accordingly, since the discharge tray 16 is capable of changing the placement angle θ2 to the first placement angle θ21 and the second placement angle θ22 larger than the first placement angle θ21, it is easy to secure the alignment of the medium 3 discharged onto the placement surface 17 of the discharge tray 16.

Further, the discharge roller pair 24 is capable of changing, with the roller drive section 42, the discharge speed V to the first discharge speed V1, the second discharge speed V2 lower than the first discharge speed V1, and the third discharge speed V3 lower than the second discharge speed V2. The control section 71 is configured to change the discharge speed V from the first discharge speed V1 to the second discharge speed V2 while the medium 3 is discharged at the second placement angle θ22, change the discharge speed V from the first discharge speed V1 to the third discharge speed V3 while the medium 3 is discharged at the first placement angle θ21, and discharge the medium 3.

Accordingly, the discharge speed V of the discharge roller pair 24 is reduced from the first discharge speed V1 to the second discharge speed V2 at the second placement angle θ22. Since a degree of this deceleration is smaller than a degree of deceleration from the first discharge speed V1 to the third discharge speed V3, the load of the roller drive section 42 decreases by the smallness. Therefore, it is possible to suppress the power consumption involved in the deceleration while securing the alignment of the medium 3. When the discharge speed V is increased from the second discharge speed V2 to the first discharge speed V1, since a degree of the acceleration is smaller than a degree of acceleration from the third discharge speed V3 to the first discharge speed V1, the load of the roller drive section 42 decreases by the smallness. Therefore, it is possible to suppress the power consumption.
(2) In the present embodiment, while the discharge roller pair 24 is discharging the medium 3, timing when the discharge speed V is reduced from the first discharge speed V1 to the second discharge speed V2 is when the trailing end portion 3E of the medium 3 is discharged. Timing when the discharge speed V is reduced from the first discharge speed V1 to the third discharge speed V3 is also when the trailing end portion 3E of the medium 3 is discharged. Accordingly, since a time in which the discharge speed V is reduced decreases, it is possible to suppress the power consumption involved in the deceleration.
(3) In the present embodiment, a deceleration degree between the first discharge speed V1 and the second discharge speed V2 at the second placement angle θ22 is set smaller than a deceleration degree between the first discharge speed V1 and the third discharge speed V3 at the first placement angle θ21. Accordingly, it is possible to further suppress power consumption involved in the deceleration.
(4) In the present embodiment, the control section 71 sets the placement angle θ2 to the first placement angle θ21, the second placement angle θ22, or the like based on the information concerning the size and the placement direction of the medium 3. That is, the control section 71 is configured to set the placement angle θ2 to the first placement angle θ21, the second placement angle θ22, or the like based on the information such as the size of the medium 3. Accordingly, it is possible to suppress the power consumption involved in the deceleration while securing the alignment of the medium 3.
(5) In the present embodiment, the control section 71 is configured to set the placement angle θ2 to the first placement angle θ21, the second placement angle θ22, or the like based on the basis weight of the medium 3. Accordingly, it is possible to further suppress the power consumption involved in the deceleration while securing the alignment of the medium 3.

### Second Embodiment

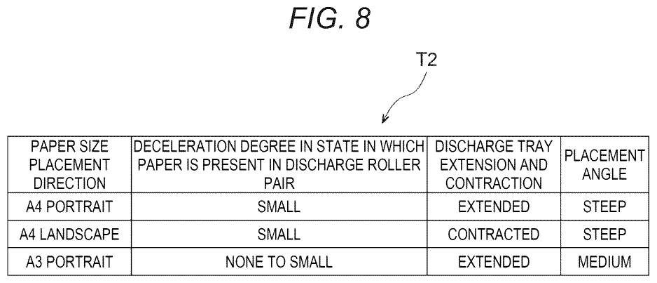

Next, the medium discharge device 21 according to a second embodiment is explained with reference to FIGS. 1 and 8. The same portions as the portions in first embodiment are denoted by the same reference numerals and signs and explanation of configurations of the portions and effects corresponding to the configurations is omitted.

As illustrated in FIG. 1, in the present embodiment, the placement surface 17 of the discharge tray 16 is configured to be extendable in the discharge direction S by the placement surface length changing section 45 such that the length of the placement surface 17 can be changed. That is, as explained above, the discharge tray 16 includes the extension tray 44. The control section 71 is configured to set the length of the placement surface 17 based on information concerning a size and a placement direction of the medium 3. The second embodiment is equivalent to a structure in which the length of the placement surface 17 being increased and reduced by the extension tray 44 is added to the first embodiment.

FIG. 8 is a control table T2 for the length of the placement surface 17 set based on sizes (A4, A3, and the like) and placement directions (portrait and landscape) of the medium 3 such as paper. As illustrated in FIG. 1, the control section 71 includes the control table T2 to be executable.

The length of the placement surface 17 is indicated as discharge tray extension and contraction. A state in which the extension tray 44 is extended to increase the placement surface 17 in length (the broken line in FIG. 1) is indicated as “extended”. A state of the placement surface 17 without the extension tray 44 being extended (the solid line in FIG. 1) is illustrated as “contracted”.

### Explanation of Decelerated Discharge and Extension and Contraction of the Placement Surface in the Second Embodiment

When receiving the information concerning the paper size and the placement direction, the control section 71 drives the placement surface length changing section 45 based on the control table T2 to set the length of the placement surface 17.

Specifically, in the case of “A4 portrait”, the discharge tray 16 is “extended”, that is, the extension tray 44 is extended and the length of the placement surface 17 increases. Also in the case of “A3 portrait”, the discharge tray 16 is “extended”, that is, the extension tray 44 is extended and the length of the placement surface 17 increases. In the case of “A4 landscape”, the discharge tray 16 is “contracted”, that is, the length of the placement surface 17 is length in a state in which the extension tray 44 is not extended.

In the present embodiment, the control section 71 sets the length of the placement surface 17 based on the information concerning the size and the placement direction of the medium 3. Accordingly, it is possible to place the entire medium 3 on the placement surface 17 of the discharge tray 16 and it is possible to suppress power consumption involved in deceleration while securing alignment of the medium 3.

### Third Embodiment

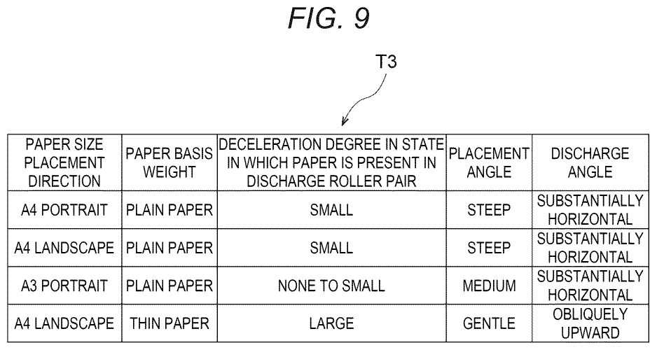

Next, the medium discharge device 21 according to a third embodiment is explained with reference to FIGS. 1 and 9. The same portions as the portions in first embodiment are denoted by the same reference numerals and signs and explanation of configurations of the portions and effects corresponding to the configurations is omitted.

As illustrated in FIG. 1, the discharge roller pair 24 is configured to be capable of changing, with the discharge angle changing section 19 (FIG. 3), the discharge angle θ1 at which the medium 3 is discharged in the discharge direction S. The control section 71 is configured to set the discharge angle θ1 according to a basis weight of the medium 3. The third embodiment is equivalent to a structure in which changing the discharge angle θ1 is added to the first embodiment.

FIG. 9 is a control table T3 for the discharge angle θ1 set based on sizes (A4, A3, and the like) and placement directions (portrait and landscape) of the medium 3 such as paper and the basis weight of the medium 3. As illustrated in FIG. 1, the control section 71 includes the control table T3 to be executable.

The discharge angle θ1 is indicated by “substantially horizontal” and “obliquely upward”.

The control table T3 is created in advance from the viewpoint of making it possible to suppress the power consumption involved in the reduction of the discharge speed V while ensuring the alignment of the medium 3 discharged onto the placement surface 17 taking into account “(1) the relationship between the discharge speed and the alignment”, “(2) the relationship among the discharge speed, the placement angle, and the alignment”, and “(3) the relationship between the discharge angle and the alignment” explained above.

### Explanation of Decelerated Discharge and a Change in Discharge Speed in the Third Embodiment

When receiving the information concerning the paper size and the placement direction and further receiving the information concerning the basis weight of the medium 3, the control section 71 drives the discharge angle changing section 19 to set the discharge angle θ1 based on the control table T3.

Specifically, in the case of “A4 portrait plain paper”, the medium 3 is discharged in a direction in which the discharge angle θ1 is “substantially horizontal”. Also in the case of “A4 landscape plain paper”, the medium 3 is discharged in the direction in which the discharge angle θ1 is “substantially horizontal”. Also in the case of “A3 portrait plain paper”, the medium 3 is discharged in the direction in which the discharge angle θ1 is “substantially horizontal”. On the other hand, in the case of “A4 landscape thin paper”, the medium 3 is discharged in a direction in which the discharge angle θ1 is “obliquely upward”.

In the present embodiment, the control section 71 is configured to set the discharge angle θ1 according to the basis weight of the medium 3. Accordingly, it is possible to further suppress the power consumption involved in the deceleration while securing the alignment of the medium 3.

### Other Embodiments

The medium discharge device 21 and the image reading apparatus 1 according to the present disclosure is based on having the configurations in the embodiments explained above. However, it is naturally possible to, for example, change and omit partial configurations without departing from the gist of the present disclosure.

What is claimed is:

1. A medium discharge device comprising:
a discharge roller pair configured to discharge a medium in a discharge direction;
a roller drive section configured to drive rollers configuring the discharge roller pair;
a discharge tray including a placement surface on which the medium discharged from the discharge roller pair is placed, the discharge tray changing a placement angle in the discharge direction of the placement surface;
a placement angle changing section configured to change the placement angle of the discharge tray; and
a control section configured to control operations of the roller drive section and the placement angle changing section, wherein
the discharge tray changes, with the placement angle changing section, the placement angle to a first placement angle and a second placement angle larger than the first placement angle,
the discharge roller pair changes, with the roller drive section, discharge speed to first discharge speed, second discharge speed lower than the first discharge speed, and third discharge speed lower than the second discharge speed, and
the control section changes the discharge speed from the first discharge speed to the second discharge speed while the medium is discharged at the second placement angle, changes the discharge speed from the first discharge speed to the third discharge speed while the medium is discharged at the first placement angle, and discharges the medium.

2. The medium discharge device according to claim 1, wherein the control section changes the discharge speed from the first discharge speed to the second discharge speed when the discharge roller pair discharges a trailing end portion of the medium at the second placement angle, changes the discharge speed from the first discharge speed to the third discharge speed when the discharge roller pair discharges the trailing end portion of the medium at the first placement angle, and discharges the medium.

3. The medium discharge device according to claim 1, wherein a deceleration degree between the first discharge speed and the second discharge speed at the second placement angle is smaller than a deceleration degree between the first discharge speed and the third discharge speed at the first placement angle.

4. The medium discharge device according to claim 1, wherein the control section sets the placement angle to the first placement angle or the second placement angle based on information concerning a size and a placement direction of the medium.

5. The medium discharge device according to claim 4, wherein the control section sets the placement angle to the first placement angle or the second placement angle based on a basis weight of the medium.

6. The medium discharge device according to claim 4, wherein
the placement surface of the discharge tray extends and contracts in the discharge direction,
the medium discharge device comprises a placement surface length changing section configured to change length of the placement surface of the discharge tray, and
the control section sets the length of the placement surface based on the information concerning the size and the placement direction of the medium.

7. The medium discharge device according to claim 4, wherein
the discharge roller pair changes a discharge angle at which the medium is discharged in the discharge direction,
the medium discharge device comprises a discharge angle changing section configured to change the discharge angle, and
the control section sets the discharge angle according to a basis weight of the medium.

8. An image reading apparatus comprising:
the medium discharge device according to claim 1; and
a reading section located further upstream than the medium discharge device in a conveyance direction of the medium and configured to read an image of the conveyed medium.
